(19) United States
(12) Patent Application Publication
(10) Pub. No.: US 2013/0155964 A1
(43) Pub. Date: Jun. 20, 2013

(54) ALLOWING END-USER DEVICES ACCESS TO RESOURCES OF A MOBILE BROADBAND NETWORK AT DESIRED QUALITY OF SERVICE LEVELS USING A TRANSIT DEVICE

(71) Applicants: Trent J. Miller, West Chicago, IL (US); Anatoly Aquinik, Deerfield, IL (US); Tyrone D. Bekiares, Chicago, IL (US); Lin Lin, Fox River Grove, IL (US); James A. Marocchi, Winfield, IL (US); Francesca Schuler, Palatine, IL (US)

(72) Inventors: Trent J. Miller, West Chicago, IL (US); Anatoly Aquinik, Deerfield, IL (US); Tyrone D. Bekiares, Chicago, IL (US); Lin Lin, Fox River Grove, IL (US); James A. Marocchi, Winfield, IL (US); Francesca Schuler, Palatine, IL (US)

(73) Assignee: MOTOROLA SOLUTIONS, INC., SCHAUMBURG, IL (US)

(21) Appl. No.: 13/330,246

(22) Filed: Dec. 19, 2011

(51) Int. Cl. H04W 72/08; H04W 12/04; H04W 28/16

(52) U.S. Cl. 370/329; 370/328

(57) ABSTRACT

A service request (150) having a predefined QoS (152) can be received from an end-user device (105) by a transit device (110). The transit device (110) can act as an access point for the end-user device (105) to connect to a mobile broadband network (135). A transport resource (130) of the transit device (110) can be allocated to handle a data flow of the received service request (150). The network address of the allocated transport resource (130) can be recognized by the mobile broadband network (135). The network addresses associated with data packets (160) of each data flow supporting the service request (150) can be translated by the transit device (110). The translation can occur between the network address of the end-user device (105) and the network address of the transport resource (130) allocated to the data flow based upon a directionality of the data packets (160).

### FIELD OF THE DISCLOSURE

The present invention relates to mobile broadband networks, and more particularly to using a transit device as a proxy to allow end-user devices access to the resources of a mobile broadband network.

### BACKGROUND

Mobile broadband networks (e.g., digital radio, 3G, 4G, WiMAX, LTE, etc.) afford users the ability to communicate from anywhere within their service areas. Connectivity to mobile broadband networks is further increased by the ability for a transit device, to act as an interworking mobile gateway for a set of proximate end-user devices to access a mobile broadband network through the transit device.

For example, a vehicular subscriber module installed in a public safety vehicle provides network connectivity for the end-user devices of the public safety officers in its vicinity. In another example, many newer models of smart phones are able to act as an interworking mobile gateway to the Internet for other end-user devices via their mobile broadband network.

In such a situation, the smart phone or vehicle subscriber phone (VSM) (functioning as a transit device) creates a communication network with the other end-user devices, which provides the other end-user devices with the same quality of service (QoS) as the transit device. The private local collaborative network may be shared by all end-user devices with the transit device or one private local collaborative network may exist between each end-user device and the transit device. A local collaborative network can be a short-range wireless network, such as a BLUETOOTH network, a wireless USB network, and a WIFI network. That is, the end-user devices will all receive the QoS of the transit device regardless of role, priority, or other request specific consideration.

What is needed is a solution that allows the end-user devices to request and receive QoS from a transit device, wherein the transit device interworks the collaborative QoS request with QoS methods provided by the transit device's associated broadband network. The transit device further provides confirmation to the end device of all resource management requests.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 depicts a schematic diagram of a system that enables an end-user device having to utilize resources of a mobile broadband network for a requested quality of service (QoS) even through the end-user device connects through a transit device in accordance with embodiments of the inventive arrangements disclosed herein.

FIG. 2 is a flowchart of a method detailing operation of the QoS proxy to facilitate usage of mobile broadband network resources for an end-user device communicatively linked to the transit device in accordance with embodiments of the inventive arrangements disclosed herein.

FIG. 3 is a flowchart of a method describing the handling of notifications from the mobile broadband network by the QoS proxy in accordance with embodiments of the inventive arrangements disclosed herein.

FIG. 4 shows an interaction diagram illustrating example communication between system components to provide a mobile device with the ability to request an LTE service bearer via a transit device in accordance with embodiments of the inventive arrangements disclosed herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Embodiments of the invention address enabling end-user devices to utilize resources of a mobile broadband network for a requested quality of service (QoS) when accessing the mobile broadband network via an intermediary transit device. A QoS proxy operating on the transit device can evaluate QoS policies applicable to a service request from a end-user device to determine if the end-user device is authorized to request/use the resources of the mobile broadband network. When authorized, the QoS proxy can associate the service data flows of the service request with specific transport resources of the transit device and record the association in a translation table. The QoS proxy can then modify the transport information of data packets to reflect the corresponding association in the translation table to route the data packets to the appropriate end-user device and transport resources.

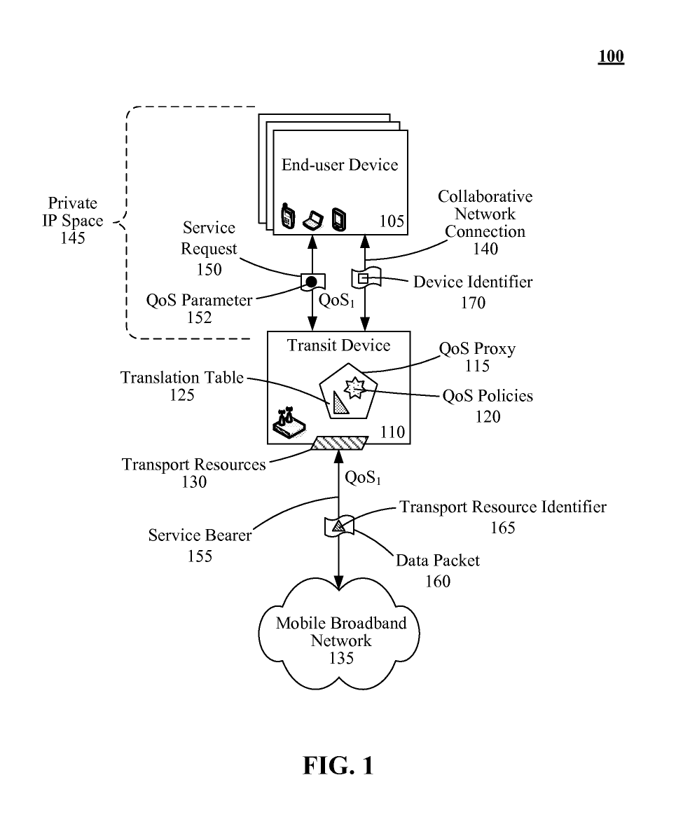

FIG. 1 depicts a schematic diagram of a system 100 that enables an end-user device 105 having to utilize resources of a mobile broadband network 135 for a requested quality of service (QoS) 152 even through the end-user device 105 connects through a transit device 110 in accordance with embodiments of the inventive arrangements disclosed herein.

In system 100, one or more end-user devices 105 can utilize the mobile broadband network 135 via a collaborative network connection 140 with the transit device 110. Utilizing the mobile broadband network 135 can refer to an ability to route packets to/from the transit device 110 (and obtain QoS from the transit device 110), where the transit device 110 ultimately routes the end-user device 105 packets to/from the mobile broadband network 105 (while using Mobile Broadband Network QoS).

The mobile broadband network 135 can be a mobile communications system capable of facilitating communications between one or more geographically dispersed and/or portable receiving units. The mobile broadband network 135 can utilize a variety of telecommunications technologies, including, but not limited to, long-term evolution (LTE), third-generation (3G), fourth-generation (4G), Worldwide Interoperability for Microwave Access (WiMax), and the like.

An end-user device 105 can represent a variety of electronic devices including, but not limited to a two-way radio, a hand-held computing device, a portable data assistant (PDA), a cell phone, a smart phone, a laptop computer, a mobile data terminal (MDT), and the like.

The transit device 110 can represent an electronic device capable of establishing a collaborative network connection 140 with an end-user device 105 and exchanging data packets 160 with the mobile broadband network 135. A local collaborative network can be a short-range wireless network, such as a BLUETOOTH network, a wireless USB network, and a WIFI network. The transit device 110 can be an end-user device 105 configured with hardware and/or software that allows it to share its connection to the mobile broadband network 135. That is, the end-user device 105 doesn't directly access mobile broadband network 135 resources. The end-device 105 accesses resources of the transit device 110 and the transit device 105 interworks QoS, formatting packets, and routing with the mobile broadband network 135. The interworking mobile gateway function of the transit device 110 can map bearer information of the mobile broadband network 135 to a local transport identifier used by each end-user device 105.

In during so, the transit device 110 can alter transport information of data packet in a data flow to ensure that the data packets are property relayed and/or interworked to the end-user device 105 from the mobile broadband network 135 and are properly relayed and/or interworked to the mobile broadband network 135 from the end-user device 105. The transport information used by the end-user device 105 can be inaccessible to the mobile broadband network 135 meaning that the mobile broadband network can lack specifics for the transport information of the end-device 105. The mobile broadband network 135 may not be able to identify or detect the presence of the end-user devices 105. The altering of the transport data can include changes at the network layer (i.e., Layer 3 changes, such as changes to an internet protocol (IP) address), changes at the transport layer (i.e., Layer 4 or even Layers 5-7, such as changes to port information). In one contemplated embodiment, the transit device 110 need not perform a translation or change to the transit information and can instead utilize a tunneling technique (e.g., Mobile IP (MIP) mobile subnet tunneling) to relay the data packets to/from the end-user device 105.

The interworking mobile gateway functionality (also able to be referred to as an interworking function or IWF), of the transit device 110 can apply to numerous communication protocols. For example, the IWF function of the transit device 110 can support Web services, IP multimedia subsystem (IMS) communications, Short Message Service (SMS) transmissions, voice over IP (VoIP) transmissions, one and two-way voice communications, real-time video, fax and email communication, or combinations thereof.

In one contemplated implementation, the transit device 110 can be a vehicular subscriber module (VSM) commonly used in public safety vehicles to provide officers using a mobile data terminal (MDT) or laptop to access to a public safety computer network via the mobile broadband network 135. In one example, a VSM equipped with WiFi can enable end-user devices 105 to access the broadband network 135 using local WiFi. As an alternate example, the transit device 110 can be a smart phone 105 having the hardware and software that allows it to let other end-user devices 105 to access the Internet using its connection to the mobile broadband network 135.

The collaborative network connection 140 between the end-user device 105 and the transit device 110 can be established using a variety of technologies supported by both devices 105 and 110, such as a physical network cable, BLUETOOTH transceivers, 802.11x transceivers, and wireless network transceivers. The collaborative network connection 140 can create a local or personal network between the end-user device 105 and transit device 110. Thus, the collaborative network can be also referred to as a local collaborative network. In one embodiment, a local collaborative network can include a personal area network (PAN), a WIFI network, a wireless USB network, a ZIGBEE network, an ad-hoc network, or any network (wired or wireless) of a limited range, such as 200 yards or less.

Thus, the end-user devices 105 can be thought of as operating in different transport space, such as a private IP space 145. This means that the IP addresses that identify the end-user devices 105 to the transit device 110 cannot be known by the mobile broadband network 135 (i.e., the mobile broadband network 135 only “sees” the transit device 110). It is this masking of the end-user devices 105 by the transit device 110 that can inhibit access to the resources of the mobile broadband network 135 in conventional systems. As noted, the transport information that is hidden from the mobile broadband network 135 is not limited to IP addresses, and can additionally or alternatively include Layer 4 or even Layer 5-7 information in various contemplated embodiments.

The transit device 110 of system 100 can overcome the obstacle of the transport information being hidden from the mobile broadband network 135 through the use of a QoS proxy 115 that maps the private IP space 145 identifier 170 of the end-user device 105 to identifier 165 of an appropriate transport resource 130 of the transit device 110 that is known by the mobile broadband network 135. The QoS proxy 115 can represent the hardware and/or software components that provide the end-user devices 105 communicatively linked to the transit device 110 with awareness of and access to mobile broadband network 135 resources (i.e., service bearers 155 of a specific QoS).

When the QoS proxy 115 receives a service request 150 from a end-user device 105, the QoS proxy 115 can evaluate one or more QoS policies 120 that are applicable to the service request 150 in order to determine if the service request 150 is able to be satisfied. If so, the request is interworked with a suitable QoS service request of the mobile broadband network 135. In one embodiment, the QoS indication for a desired service request level can be conveyed to the transit device from the end-user device 105, which sent the service request 150. In one embodiment, the end-user device 105 can send a reference or reference data for signaling dataflow (e.g., Push-to-Talk or PTT) to the transit device 110, where the transit device 110 uses stored configuration information associated with PTT to determine a desired QoS for a corresponding dataflow. Thus, the reference is considered a QoS indication in the example. In still another embodiment, a QoS profile can be associated with the end-user device 105 or with a user of the end-user device 105, which is referenced for the service request 150 and used to determine a QoS level for the data flow established as a result of the service request 150. The QoS profile can be stored in a data store of network 135 or in any storage location accessible by the transit device 110, which includes a data store internal to the transit device 110. Appreciably, different users can utilize a single end-user device 105, so in embodiments where the QoS profile is linked to a person, additional steps to determine/infer a user of the end-user device is necessary so that the transit device 110 references the proper QoS profile.

The QoS policies 120 can define the handling of service requests 150 with respect to accessing the mobile broadband network 135 for combinations of conditional parameters. Examples of these conditional parameters can include, but are not limited to the end-user device 105, a user of the end-user device 105, the user's role, the user's priority, the end-user device's 105 priority, time of day, type of service request 150, end-user device application, the available resources of the transit device 110, and/or organizational policies. The QoS policies 120 can be configured and maintained by an administrator or user of the transit device 110. In one embodiment, end-user device 105 users can be authorized to configure QoS policy 120 settings/parameters that correspond to that user's QoS profile.

The QoS proxy 115 can assign authorized service requests 150 to one or more transport resources 130 of the transit device 110. A transport resource 130 can represent communication elements of the transit device 110 associated with the transport layer of the Open Systems Interconnection (OSI) model and/or associated with a network layer that are used to communicate with the mobile broadband network 135. A port address and an IP address are two examples of transport resources 130. Transport resources 130 can include Layer 3, 4, and even Layer 5-7 resources. Transport resources 130 can affect a manner in which a data flow is provided to/from a device, such as end-user device 105.

The QoS proxy 115 can be configured to multiplex traffic from multiple end-user devices 105 onto the same transport resource 130, providing the transport resource 130 is able to support the additional usage. The traffic from multiple end-user devices 105 may need to have the same QoS in order to utilize a common transport resource 130. In one embodiment, the transit device 110 can function as an interworking mobile gateway for more than one end-user devices 105 concurrently. Thus, multiple different data flows can concurrently be conducted through a set of end-user devices 105 that utilize the transit device 110 as an interworking mobile gateway. These concurrent data flows can each have a flow-specific QoS level associated with it.

In one embodiment, the QoS proxy 115 can record the correlation between the identifier 170 of the end-user device 105 in the private IP space 145 and an identifier 165 of the assigned transport resources 130 in a translation table 125. The QoS proxy 115 can then modify the service request 150 to reflect the identifier 165 of the assigned transport resource 130 and pass the modified service request 150 to the mobile broadband network 135. The translation table 125 can be a network address translation (NAT) table (for IPv4 and IPv6 communications, for example), can be a network address and port translation (NAPT) table (for IPv4 communications, for example), can be a port address translation (PAT) table, can maintain values for MIP tunneling, and/or the like depending on implementation choices.

The mobile broadband network 135 can handle the modified service request 150 as it would any other service request 150. When the service request 150 is granted, the mobile broadband network 135 can establish one or more service bearers 155 with the transit device 110 and address the subsequent data packets 160 with the transport resource identifier 165 specified in the modified service request 150.

As the end-user device 105 and the mobile broadband network 135 generate and send data packets 160, the QoS proxy 115 can perform a network address and/or port translation (NAPT) upon the identifiers 165 and 170 addressing the data packets 160 using the translation table 125. As noted, MIP tunneling is another contemplated implementation mechanism.

The benefit of this approach can be further illustrated by example. As shown in system 100, the transit device 110 can provide a default QoS. In a conventional system, all service requests 150 from end-user devices 105 would be handled by a service bearer 155 of the mobile broadband network 135 having this QoS (e.g., the default QoS).

However, with this approach, a end-user device 105 can issue a service request 150 with a QoS parameter 152 (of QoS₁, for example). Upon authorization of the service request 150 by the QoS proxy 115 and mobile broadband network 135, a service bearer 155 having QoS₁ can be established between the transit device 110 and mobile broadband network 135 and used to exchange the data packets 160 supporting the service.

Additionally, the QoS proxy 115 can be configured to relay and/or interwork notifications from the mobile broadband network 135. For example, the mobile broadband network 135 may need to de-allocate a service bearer 155 being used by the transit device 110, which affects applications being used by one or more end-user devices.

The QoS proxy 115 can identify which end-user devices 105 are affected and relay and/or interwork the notification to the appropriate end-user device(s). Further, the QoS policies 120 can be expanded upon to include information to assist the QoS proxy 115 in determining how to resolve instances where multiple end-user devices 105 are affected (i.e., terminate the service of only one end-user device 105, reduce the QoS of both end-user devices 105, etc.).

In system 100 the mobile broadband network 135 is not directly accessible to the end-user device 105. Instead, communications are conveyed between the end-user device 105 and the transit device 110, in between the transit device 100 and the mobile broadband network 135. “Not directly accessible” may refer to a connectivity preference or may refer to a hardware/software compatibility issue.

To elaborate, the end-user device 105 may be technologically incompatible with the mobile broadband network 135. That is, the end-user device 105 uses a different access technology than is supported by the mobile broadband network 135. A second case includes an end-user device 105 that is technologically compatible with the mobile broadband network 135, however current conditions prohibit a communication channel from being established directly between the end-user device 105 and the mobile broadband network 135. Current conditions preventing a direct end-user device 105 link with the mobile broadband network 135 include: insufficient signal, poor RF conditions, user preferences, device preferences, and the like.

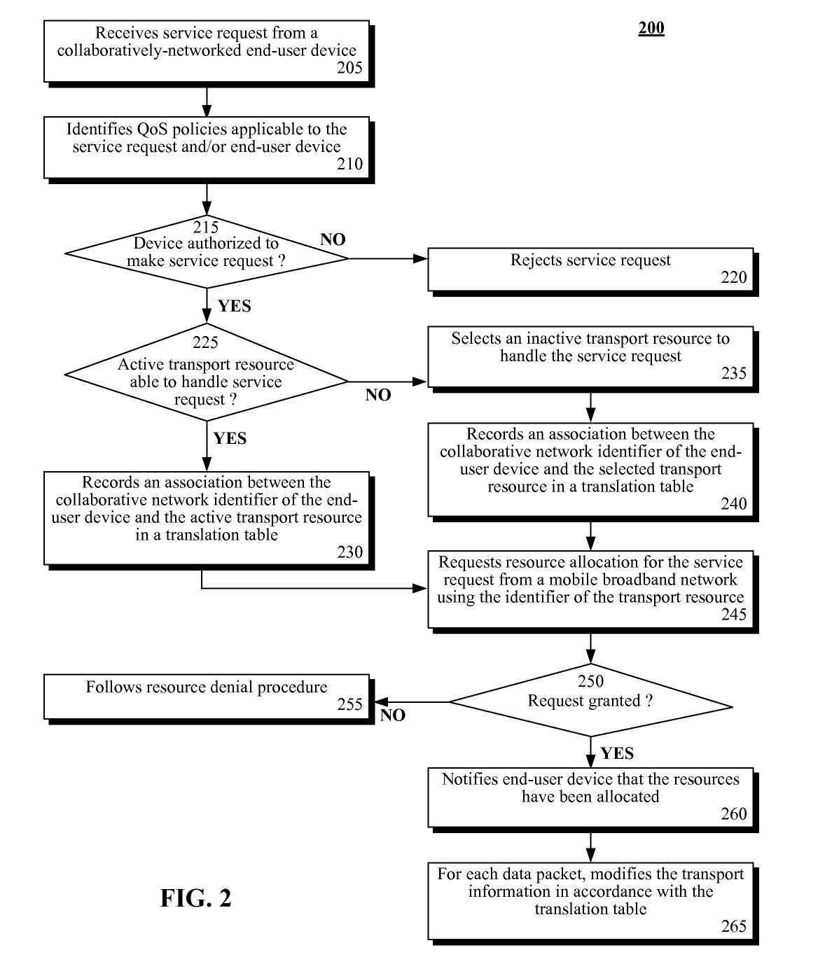

FIG. 2 is a flowchart of a method 200 detailing operation of the QoS proxy to facilitate usage of mobile broadband network resources for an end-user device communicatively linked with the transit device in accordance with embodiments of the inventive arrangements disclosed herein. Method 200 can be performed within the context of system 100.

Method 200 can begin in step 205 where the QoS proxy can receive a service request from an end-user device. The QoS policies applicable to the service request and/or end-user device can be identified in step 210.

In step 215, it can be determined if the end-user device is authorized to make the service request to the mobile broadband network. When the end-user device is not authorized, the service request can be rejected in step 220.

When the end-user device is authorized, the QoS proxy can determine if there is an active transport resource available to handle the service request in step 225. When an active transport resource is available, step 230 can be performed where an association between the collaborative network identifier of the end-user devices and an identifier of the active transport resource can be recorded in a translation table.

When an active transport resource is unavailable, an inactive transport resource can be selected to handle the service request in step 235. This transport resource can be a resource of the transit device as it is connected to the mobile broadband network. In step 240, an association between the collaborative network identifier of the end-user devices and an identifier of the selected transport resource can be recorded in a translation table.

Upon completion of step 230 or step 240, resource allocation to handle the service request can be requested from the mobile broadband network using the identifier of the transport resources (not the identifier of the end-user device). It can be determined in step 250 if the mobile broadband network has granted the resource allocation request.

When the mobile broadband network denies the request, step 255 can execute where the QoS proxy can follow its predefined resource denial procedure (i.e., notify the end-user device, wait a predetermined time period and retry the request). When the mobile broadband network grants the request, the end-user device can be notified that the requested resources have been allocated in step 260.

In step 265, the address of each data packet can be modified in accordance the translation table. That is, data packets received from the end-user device can have the private identifier of the end-user device replaced with the identifier of the transit device's transport resource and data packets received from the mobile broadband network can have the identifier of the transport resource replaced with the private identifier of the end-user device.

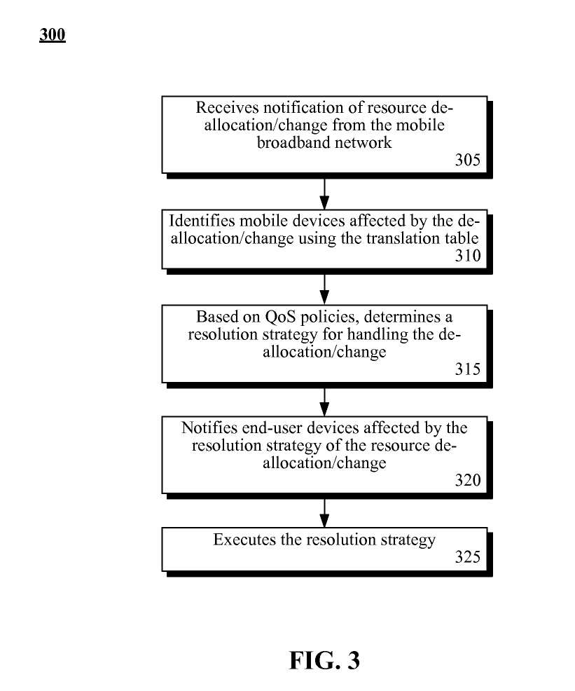

FIG. 3 is a flowchart of a method 300 describing the handling of notifications from the mobile broadband network by the QoS proxy in accordance with embodiments of the inventive arrangements disclosed herein. Method 300 can be performed within the context of system 100 and/or in conjunction with method 200.

Method 300 can begin in step 305 where the QoS proxy can receive notification of a resource de-allocation or change from the mobile broadband network. The end-user devices affected by the resource de-allocation/change can be identified using the translation table in step 310.

Based on the QoS policies, a resolution strategy for handling the de-allocation/change can be determined in step 315. In step 320 the end-user devices affected by the resolution strategy can be notified of the resource de-allocation/change. The resolution strategy can be executed in step 325.

It should be noted that step 320 can illustrate that the end-user devices identified in step 310 may not all be affected by the resolution strategy determined by the QoS proxy. For example, when a resource supporting two end-user devices is removed by the mobile broadband network, the QoS proxy can determine that the service to one of the end-user devices is to be terminated and the other re-routed to another service bearer. Thus, the end-user device whose service was terminated need only be notified in step 320, since the service of the other end-user device is not disrupted.

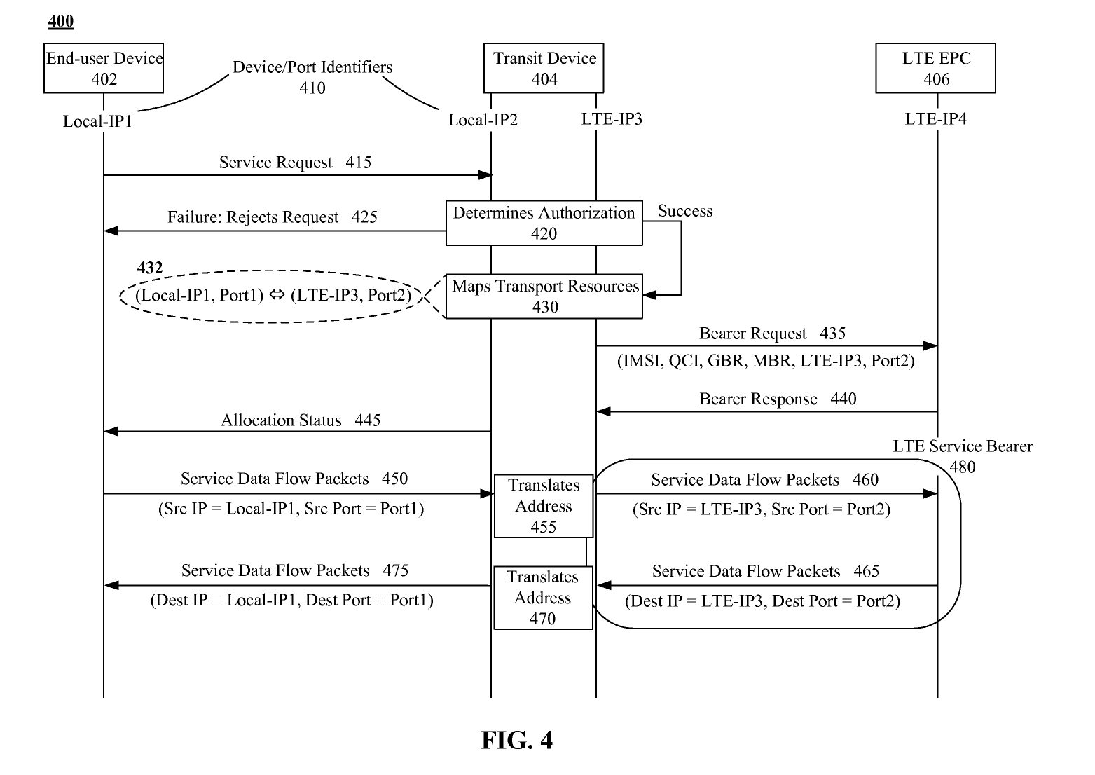

FIG. 4 shows an interaction diagram 400 illustrating example communication between system components 402-406 to provide an end-user device 402 with the ability to request a LTE service bearer 480 via a transit device 404 in accordance with embodiments of the inventive arrangements disclosed herein. The exchanges of interaction diagram 400 can occur within the context of system 100 and/or method 200.

As shown in interaction diagram 400, each component 402, 404, and 406 can have a device/port identifier 410. The transit device 404 can be shown as having two device/port identifiers 410 to emphasize the differences in addressing for the two different IP spaces that the transit device 404 conducts communications; the Local-IP2 device/port identifier 410 can be used for communicating with the end-user device 402 over the collaborative network and the LTE-IP3 device/port identifier 410 can be used for communicating with the LTE EPC 406.

Interaction can begin when the end-user device 402 issues 415 a service request to the transit device 404. The service request can contain typical information such as userID, deviceID, QoS class identifier (QCI), guaranteed bit rate (GBR), max bit rate (MBR), flow addressing, and so on.

The transit device 404 can then determine 420 the authorization of the service request using applicable QoS policies. Authorization failure can result in the transit device 404 rejecting 425 the service request. Successful authorization can trigger the transit device 404 to map 430 transport resources to the service request.

As shown in example 432, this mapping can relate the device/port identifiers 410, Local-IP1 and Port1, for a flow of the end-user device 402 with the device/port identifiers 410, LTE-IP3 and Port2, of the transit device 404 assigned to handle the flow. It should be noted that Port1 identified by the mobile device 402 can refer to the same port identified as Port2 by the transit device 404. This difference in device/port identifier 410 stems from how the LTE EPC 406 recognizes the port.

The transit device 404 can then send 435 a bearer request to the LTE EPC 406. The bearer request can include standard information and contains flow addressing for the mapped transport resource. A bearer response can be sent 440 from the LTE EPC 406 to the transit device 404. It is important to note that the present invention does not affect the air interface (bearer request 435 and bearer response 440) of the LTE EPC 406.

The bearer response can be relayed 445 and/or interworked by the transit device 404 to the mobile device 402 as an allocation status (e.g., confirmed, denied, pending, etc.). For the sake of illustration, it is assumed that the bearer response indicates a successful allocation of resources for the service request, resulting in the establishment of a LTE service bearer 480.

The end-user device 402 can then send 450 service data flow packets to the transit device 404. The service data flow packets can be addressed with the source IP and port pointing to the device/port identifiers 410 of the end-user device 402.

The transit device 404 can translate 455 the address of the service data flow packets to reflect the device/port identifiers 410 of the transport resource using the translation table. The modified service data flow packets can then be conveyed 460 to the LTE EPC 406 using the established LTE service bearer 480.

The LTE EPC 406 can send 465 the transit device 404 return service data flow packets having destination device/port identifiers 410 matching the mapped transport resource. These device/port identifiers 410 can be translated 470 by the transit device 404 to the device/port identifiers 410 of the end-user device 402 and then transmitted 475 to the end-user device 402.

It should be noted that the exchange 460 and 465 of service data flow packets between the transit device 404 and LTE EPC 406 can include additional encapsulation like when using a mobile virtual private network (mVPN).

The arrangements of the disclosure are believed to have numerous advantages over conventional techniques. Specifically, conventional techniques do not guarantee a quality of service (QOS) for a mobile broadband communication when transit device (intermediate device) is used. Use of a transit device is becoming more common, as communication environments leveraging both broadband and narrowband devices (e.g., a public safety environment) are emerging. Per the disclosure, when a set of one or more local devices (e.g., a two-way radio, cell phone, or tablet) connect over a short-range network (e.g., BLUETOOTH) to an intermediate device (e.g., wireless broadband device functioning as an access point to a mobile broadband network) the local devices are not conventionally guaranteed a QoS level, as they would be if these end-user devices were directly connected to the mobile broadband network. Instead, QoS established for the transit device is used by default. The disclosure permits different QoS levels to be established for requests from different end-user devices. This ensures priority of service is granted to end-user devices properly, which can be extremely important in many common usage situations, such as in a public safety/emergency responder environment where QoS to end-devices can be critical to maintaining communication during an emergency response incident.

Embodiments of the disclosure are not intended for mesh networking. Embodiments of the disclosure are intended to extend the tandem function of the mobile broadband network. Specifically through arrangements presented herein, end user devices can have a quality of service guaranteed when connecting through a transit device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A system for providing confirmed quality of service (QoS) for end-user devices with a transit device comprising:
a mobile broadband network;
at least one end-user device; and
a transit device acting as an interworking mobile gateway for the at least one end-user device, wherein said transit device is configured to provide QoS resource management functionality to the at least one end-user device for resources of the mobile broadband network, wherein the transit device maps QoS information of the mobile broadband network to QoS information associated with a local transport identifier used by each end-user device, wherein transport information of the at least one end-user device used by the transit device is not directly accessible by the mobile broadband network.

2. The system of claim 1, wherein the transit device is a mobile device configured to act as an interworking mobile gateway attached to the mobile broadband network.

3. The system of claim 1, wherein the mobile broadband network comprises at least one of a long-term evolution (LTE) network, a third-generation wireless communications (3G) network, a fourth-generation (4G) wireless communications network, a Worldwide Interoperability for Microwave Access (WiMAX) network, a digital radio network, and a two-way radio network.

4. The system of claim 1, wherein the transit device and end-user device are interlinked in a local collaborative network having a private IP space.

5. The system of claim 1, wherein the transit device stores a QoS profile having QoS information indexed to the end-user device or a user of the end-user device

6. The system of claim 1, wherein the transit device maps the bearer information to the local transport identifying by translating between a local IP space and the mobile broadband network, the local IP space being IPv4 or IPv6 compliant and the mobile broadband network being IPv4 or IPv6 compliant.

7. The system of claim 1, wherein said transit device is operable to:
receive a service request from one of the at least one end-user devices, wherein the service request has a corresponding quality of service (QoS) indication associated, wherein the transit device acts as an interworking mobile gateway that interworks resources of the mobile broadband network with resources needed by the end-user device on a local network;
allocate a bearer resource of the transit device to a data flow of the received service request, wherein the transport information of the at least one allocated bearer resource is recognized by the mobile broadband network; and
translate the transport information associated with data packets of each data flow supporting the service request, wherein translation occurs between the transport information of the end-user device and the transport information of the bearer resource allocated to the data flow based upon a directionality of the data packets.

8. The system of claim 1, wherein the transit device maps QoS attributes associated with a bearer of the mobile broadband network to a local bearer referenced by the local transport identifier.

9. A method for providing confirmed quality of service (QoS) for end-user devices with a transit device comprising:
receiving a service request having a quality of service (QoS) indication for an end-user device by a transit device;
the transit device acting as an interworking mobile gateway for interworking resources from a mobile broadband network to a local network that connects the transit device to the end-user device;
the transit device requesting at least one bearer resource from the mobile broadband network responsive to the service request, wherein the at least one bearer resource is provided by the mobile broadband network at a quality of service level that corresponds to the quality of service (QoS) indication; and
the transit device relaying or interworking a data flow between the end-user device and the mobile broadband network, wherein the data flow is one associated with the received service request, and wherein the data flow is provided at the quality of service level.

10. The method of claim 9, further comprising:
the transit device receiving the quality of service (QoS) indication from the end-user device, where the QoS indication specifies the quality of service level.

11. The method of claim 10, further comprising:
the transit device accessing quality of service (QoS) profile of the end-user device to determine the quality of service level.

12. The method of claim 9, further comprising:
the transit device mapping from bearer information of the mobile broadband network to a local transport identifier used by the end-user device, wherein transport information of the at least one end-user device is not directly accessible by the mobile broadband network.

13. The method of claim 9, further comprising:
translating transport information associated with data packets of the data flow supporting the service request by the transit device, wherein translation occurs between the transport information of the end-user device and the transport information of the bearer resource allocated to the data flow based upon a directionality of the data packets.

14. The method of claim 13, further comprising:
recording a correlation between the transport information of the end-user device and the transport information of the allocated bearer resource in a translation table for each data flow associated with the service request; and
requesting fulfillment of the service request by the mobile broadband network by the transit device on behalf of the end device, wherein said request identifies the transport information of the transit device as a source of the data flow of the service request, and, wherein said fulfillment establishes at least one non-default bearer resource between the mobile broadband network and the transit device, wherein the translating occurs if fulfillment of the service request is granted by the mobile broadband network.

15. The method of claim 9, further comprising:
tunneling data packets of the data flow to ensure the data flow is provided at the quality of service (QoS) level to the end-user device over the mobile broadband network and for multiplexing different end-user devices into a common bearer of the transit device.

16. The method of claim 9, wherein the transit device and end-user device are interlinked in a local collaborative network having a private IP space, wherein transport information of the end-user device is not directly accessible by the mobile broadband network.

17. The method of claim 9, further comprising:
evaluating a plurality of quality of service (QoS) policies with respect to the received service request to ascertain authorization for the end-user device to utilize resources of the mobile broadband network;
when the received service request is authorized, proceeding with the allocation of the bearer resource; and
when the received service request is unauthorized, rejecting the service request of the end-user device.

18. The method of claim 9, wherein the end-user device passes attributes to the transit device to aid in policy decision making in regard to authorization to utilize resources of the mobile broadband network at the quality of service (QoS) level, wherein the passed attributes include at least one of: role, application, incident type, and emergency state.

19. The method of claim 9, further comprising:
receiving a data packet for the data flow supporting the service request from the mobile broadband network;
identifying the end-user device associated with the bearer resource for the data flow of the received data packet using a translation table;
replacing transport information of the bearer resource in the data packet with the transport information of the identified end-user device; and
conveying the data packet to the end-user device using a local collaborative network that connects the transit device to the end-user device.

20. A computer program product comprising a computer readable storage medium having computer usable program code embodied therewith, the computer usable program code comprising:
computer usable program code configured to receive a service request having a quality of service (QoS) indication from a mobile communications device by a transit device, wherein the transit device acts as a mobile interworking gateway for interworking resources from a mobile broadband network to a local network that connects the transit device to the end-user device;
computer usable program code configured to allocate a bearer resource of the transit device to a data flow of the received service request, wherein the transport information of the at least one allocated bearer resource is recognized by the mobile broadband network; and
computer usable program code configured to translate the transport information associated with data packets of each data flow supporting the service request by the transit device, wherein translation occurs between the transport information of the mobile communications device and the transport information of the bearer resource allocated to the data flow based upon a directionality of the data packets.
